(19) United States
(12) Patent Application Publication
(10) Pub. No.: US 2025/0014240 A1
(43) Pub. Date: Jan. 9, 2025

(54) User Interactive Responsive UML

(71) Applicant: Narendra Kumar Narayanan, LIVERMORE, CA (US)

(72) Inventor: Narendra Kumar Narayanan, LIVERMORE, CA (US)

(21) Appl. No.: 18/642,749

(22) Filed: Apr. 22, 2024

Related U.S. Application Data
(60) Provisional application No. 63/498,017, filed on Apr. 25, 2023.

(51) Int. Cl. G06T 11/20; G06F 40/14

(52) U.S. Cl. CPC G06T 11/206; G06F 40/14; G06T 2200/24

(57) ABSTRACT

The invention is an improvement over the existing UML and non UML script based diagram drawing tools to show an optimal and reduced initial presentation of the diagram, to provide the user with the controls to both view and re-define conditions of branches and their list of possible values in real time and to update the diagram with different versions corresponding to the values that the user optionally chooses for these conditions.

### FIELD OF INVENTION

The invention pertains to the improvements in the current diagramming tools to
allow the user viewing the diagram to interact with the diagram in real time.
read the inputs from the user through their interactions.
apply inputs from user's interactions and redraw the diagram accordingly.

The invention applies to all script diagram types and specifications that have scripts that allow branches that are based on conditions.

### BACKGROUND

### Static Diagrams:

Currently, diagram drawing tools draw the diagrams as static diagrams. The diagram is to be interpreted after it is drawn by the drawing tool. It is interpreted as a document, separate from the script itself. This is true for UML diagrams from both the tools that require the user to manually create the script and those that provide a drag and drop user interface with an implicitly managed internal script.

UML and non UML diagrams as of now, don't provide a way for the user, an important consumer of these diagrams, to interact with the diagrams in real time.

### Presentation of Complex and Large Diagrams:

If the diagram becomes more and more complex in terms of the number of components, activities, interactions, sequences and flows etc., chances are that the diagram might become more and more cluttered and larger. This might result in the diagram not being an optimally user-friendly presentation of the complex diagram that is being drawn. The clarity and so the usefulness of the diagram will suffer.

There must be a more intuitive and simpler approach to present the complex diagram than a cluttered static diagram.

### THE INVENTION

The invention aims to solve these issues by presenting the diagram in a novel way as described further here.

### BRIEF SUMMARY OF THE INVENTION

The invention has two main aspects.
One is at the user interface level by presenting the diagram in a novel way and
the other is the functional features of the invention.

### THE USER INTERFACE ASPECTS OF THE INVENTION

The invention
presents an initial optimized presentation of the diagram.
provides controls to the user to interact with the diagram in real time.
responds to the user's interactions by reading their interactions and re-drawing the other possible versions of the diagram dynamically in real time.

### THE FUNCTIONAL ASPECTS OF THE INVENTION

The invention by way of providing a two way interaction between the user and the diagram achieves its functional goals. One important goal is to make the presentation of complex diagrams more modular and clearer than the static diagrams from the existing UML drawing tools of today.

The invention makes the presentation modular by
identifying sections of the diagrams that are fit for modular presentation. One example is to look for mutually exclusive or optional sections of the script and the conditions governing them.
recording these conditions and their possible values.
choosing an initial default value for these conditions and draw the initial optimized reduced presentation of the diagram.
providing controls to the user to dynamically optionally re-define the conditions, their list of possible values, either all or a partial set of them.
providing the controls to the user to dynamically optionally change the actual selected values for these conditions, different from the default values selected by the invention software.
updating the diagram with a different presentation as per the interactions of the user.

### BRIEF DESCRIPTION OF THE DRAWINGS

FIG. 1: This is a flowchart showing the invention software extending the capabilities of the current diagram drawing tools to parse for sections in the script that are fit for modularized presentation and drawing the default reduced presentation to the user.

FIG. 2: This figure shows how the user interacts with the invention software, User Interactive Responsive UML and how it updates the diagram accordingly.

FIG. 3: This diagram shows how the current UML swim lane activity diagram drawing tools display a complex swim lane activity diagram for a user making a purchase.

FIG. 4: This diagram shows how the current UML swim lane activity diagram drawing tools can display a simplified version of the swim lane activity diagram in FIG. 3 by removing the two conditions.

FIG. 5: This diagram also shows how the current UML swim lane activity diagram drawing tools displays another simplified version of the swim lane activity diagram in FIG. 3 by removing the two conditions.

FIG. 6: This diagram shows how the invention software shows the swim lane activity diagram in FIG. 3 with its first default presentation to the user.

FIG. 7: This diagram shows how the invention software redraws the swim lane activity diagram in FIG. 6 differently when the user chooses different selected value, “False” for the two conditions, “In-Store” and “Coupon”.

FIG. 8: This diagram shows how the invention software allows the user to redefine the condition, “In-Store” to “Purchase Mode” and the possible values of these conditions appropriately from “True to “In-Store” and from “False” to “Online”.

FIG. 9: This diagram shows how the current UML drawing tools draw a sequence diagram with two conditions, namely, “Balance>$1000” and “$1000>=Balance>$300”.

FIG. 10: This diagram shows how the invention software shows the sequence diagram as its first default presentation to the user.

FIG. 11: This diagram shows how the invention software redraws the same sequence diagram in FIG. 10 differently when the user chooses different selected value, namely, “False” for the condition, “Balance>$1000”.

FIG. 12: This shows how the invention software allows the user to club the conditions, “Balance>$1000” and “$1000>=Balance>$300” into a single user defined condition, “Balance” and the previous two lists of two values into a single list of three values.

### DETAILED DESCRIPTION OF THE INVENTION

The following section describes the invention in detail.

### The Problem

Today's diagram drawing tools render the UML diagrams from either a script, UML or otherwise, if the user provides the script or from a drag and drop user interface, where the UML or non UML script is internally implicitly managed. As the number of branches in the diagram increase, the diagram gets more complex and larger. It is not possible to make the diagram smaller without changing the script by removing some of the branching conditions and replacing them with a single value for the conditions.

It is more useful and intuitive to provide an optimal reduced presentation of the diagram initially and then allow the user the option to view the other possible presentations.

### Solution Outline

This requires a diagramming tool that allows the user to interact with it and responds to their interactions by providing different instances of the presentation corresponding to their interactions. Currently no UML drawing tool has these features.

Showing an initial reduced presentation of the system makes the diagram a lot less complex than a single diagram showing all the complexities.

The user might also want to compare and contrast different instances of the presentation, or might want to demonstrate this comparison to others by being able to switch between these instances of the presentations interactively like in the case of a flow engine, whose flow changes according to different selected values of the flow conditions.

### Solution

The invention adds the ability to today's diagram drawing tools to
allow the user to interact with it.
respond to the interactions from the user by dynamically updating the diagram by redrawing the diagram.
enhance the clarity of the diagram by making the presentation of the diagram modularized and make it dynamic and responsive using the user interface.

### Default Presentation of the Diagram

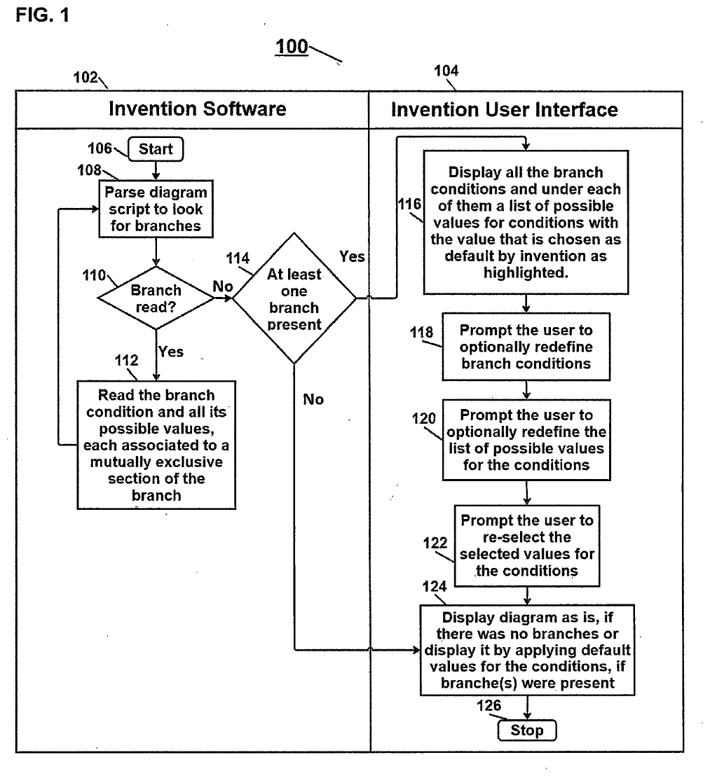

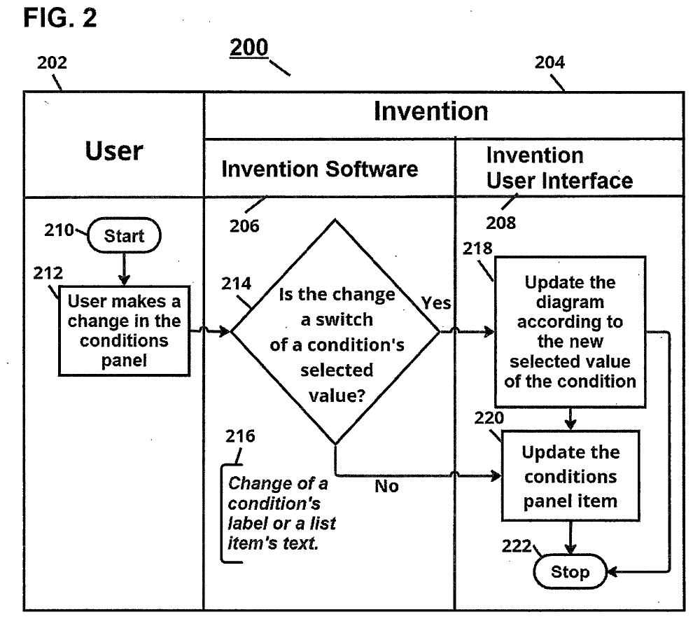

FIG. 1 and FIG. 2 show how the invention software works to solve the problem described above.

In order to make the presentation of the diagram modular, the invention needs to identify set of sections in the script that are fit for modularized presentation as shown by reference numbers, 108 and 110 of FIG. 1. One place to look for such sections are those that are sets of mutually exclusive sections of the diagram, since they provide an opportunity to reduce the complexity by presenting only one of the mutually exclusive section at a time. Usually in UML or even non UML scripts, such set of sections are conditional sections mentioned in the script itself.

So, the invention looks for conditions and options in the script that can be used to carve out only the relevant portions of the script and so the diagram, corresponding to default selected values of these conditions and/or options decided by the invention software.

The invention finds out these conditions from the script and all the possible values of the condition, each corresponding to a mutually exclusive section of the diagram as shown by the reference number 112 in FIG. 1. The syntax of these conditions might vary between the types of UML and non UML diagrams and between different UML or non UML diagram script specifications. It depends on the constructs and syntax of the script in which the UML or non UML script is written and is orthogonal to the invention's gist.

If the invention finds at least one branch condition in the script, the invention does the following. It displays all the conditions, their possible list of values and their selected values highlighted in the Conditions Panel as shown by reference number 116 of FIG. 1. Then the invention software provides the user with the prompt to optionally re-define the conditions and their list of possible values as shown by reference numbers, 118 and 120 of FIG. 1. Additionally the invention software shows the default selected values of the conditions as a highlighted item in the list of possible values. The invention software also prompts the user to optionally select actual selected values for these conditions as shown by reference number, 122 of FIG. 1.

If there was at least one branch condition in the script, the invention displays the first reduced version of the diagram by applying default values for the conditions, out of the possible list of values, identified by the invention software from the script itself. If there was no branch condition, then the invention displays the diagram without the Conditions Panel. These two scenarios are shown by reference number, 124 of FIG. 1.

### User's Interaction and the Invention's Response

How the user interacts with the Diagram using the Conditions Panel and how the invention software responds is shown by FIG. 2.

The invention software allows the user at a time to modify the label of a condition or one of the list of possible values of the conditions or choose a different selected value for a condition as shown by reference number, 212 of FIG. 2. The invention software checks, if the change by the user is a switch of the selected value of a condition as shown by reference number, 214 of FIG. 2. If it is, the invention software redraws the diagram by applying the new selected value for the condition and highlighting the new selected value in the Conditions Panel as shown by reference number, 218 and 220 of FIG. 2. If the change is not a switch of a selected value of a condition, it has to be either a change of a condition's label or the text of a list item of the possible values of a condition. Both these don't require an update to the diagram itself, so the invention stops with just making changes to the user interface items in the Conditions Panel as shown by reference number, 220 of FIG. 2.

Let us analyze the solution more closely with an example described below.

### Example

For example, UML swim lane activity diagrams that show how payment processing happens in the purchase of good(s) by an in-store credit card transaction and an online card on file transaction can have both the common aspects and differences.

With the current UML diagram drawing tools, the possibilities of drawing it are either
showing both these types of transactions in one diagram or
showing them as two separate unconnected diagrams each depicting one way of the transaction. The latter requires changing the UML script.

“SCRIPT_PURCHASE_CLUTTERED.UML” is an example UML swim lane activity diagram script written using plantuml specification as defined under, “https://plantuml.com/”. This script can be verified by copying and pasting it to the site, “https://www.plantuml.com/plantuml/uml/”.

Please note that the invention is not limited to specifications of plantuml but can be extended to all other UML diagram specifications and other non UML script based diagram specifications, where there is a scope for modularization of its presentation.

### SCRIPT_PURCHASE_CLUTTERED.UML

```
        @startuml
|User|
start
if(In-Store) then (yes)
      |Store|
      :Goes to store;
      :Uses credit card;
      :purchases good(s);
    if(coupon applied) then (yes)
    :discounted price;
    else
    :regular price;
      endif
      |Acquirer|
else (no)
      |Browser|
      :Uses browser;
      |Merchant Site|
      :logs in;
      :Access card on file;
      :purchase good(s);
    if(coupon applied) then (yes)
    :discounted price;
    else
    :regular price;
    endif
      |Acquirer|
endif
|Acquirer|
:txn request;
|Credit Card Network|
:txn request;
:validation;
|Issuer Bank|
:txn request;
:approves txn;
|Credit Card Network]
:approval;
|Acquirer|
:approval;
if(In-Store) then (yes)
      |Store|
      :approval;
else (no)
    |Merchant Site|
    :approval;
|Browser|
      :approval;
endif
|User|
:approval;
stop
@enduml
```

The above UML swim lane activity script and so the UML swim lane activity diagram have sections that correspond to how the purchase of the good(s) and the resulting transaction approval happen for both the modes of transaction, namely, one using credit card at the store and the other over online using card on file system, where the credit card information is securely stored and accessed online. For keeping it simpler, all possible actors on the merchant side is represented by “Merchant site” in the example.

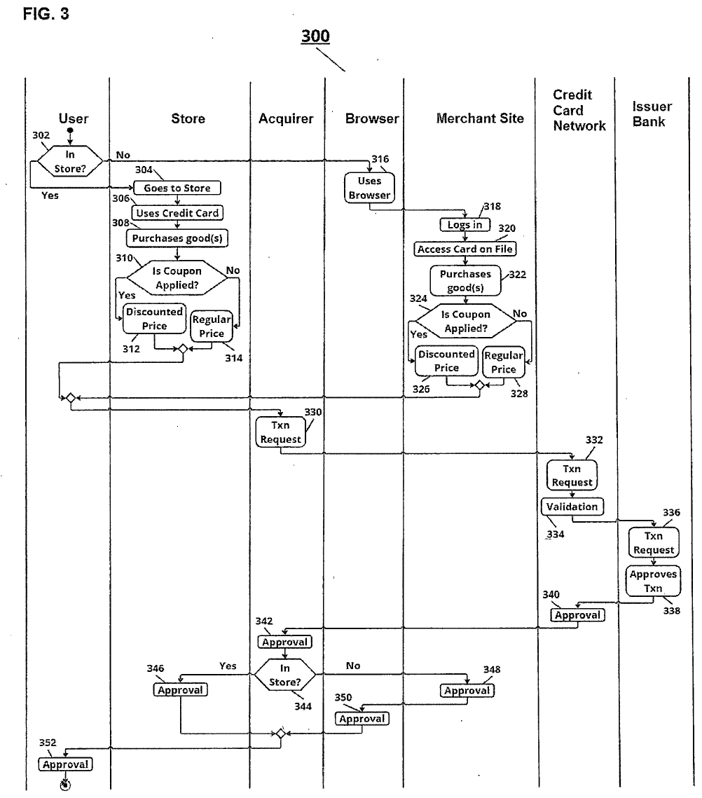

The diagram, FIG. 3 shows how the current UML tools of today draw the UML swim lane activity diagram for the transactions in the script.

As it can be seen from the diagram, FIG. 3, there are parts of the diagram, which are similar in both the in-store and online modes of the transaction. And then there are sections of the diagram that are distinct for these modes.

DISTINCTIONS: The user initiating the purchase of the good(s) is distinct in both the modes. The user uses a physical credit card in person at the store in case of in-store transaction as shown by reference numbers 304 to 308 of FIG. 3 and they use a remote card on file in case of an online transaction as shown by reference numbers 316 to 322 of FIG. 3. The other distinction is that the final approval is passed to the merchant site from the acquirer in case of the online transaction as shown by reference number 348 of FIG. 3 and to the physical store in case of in-store transaction as shown by reference number 346 of FIG. 3. Within each of these transaction types, there are differences based on, if a coupon is applied during the purchase or not, as shown by reference numbers, 310 to 314 and 324 to 328 of FIG. 3.

SIMILARITIES: The transaction request from the acquirer is routed through the same actors for both modes of transaction between the acquirer and the issuer, namely from acquirer to credit card network and from credit card network to the issuer as shown by reference numbers 330 to 336 of FIG. 3. The Issuer on approving the transaction also sends back the approval response through the same actors in both the modes of the transaction, namely from the Issuer to the credit card network and from the credit card network to the acquirer as shown by reference numbers 338 to 342 of FIG. 3.

BETTER APPROACH: There is another way to draw the diagram and that is just to show only one mode of transaction at a time and be able to switch between these modes by the user at will through a user interface. The clarity in showing just one mode of transaction is realized even more, if the diagram adds a few more modes of transaction, such as cash transaction, gift card transaction, contactless credit card transaction etc. A diagram that shows all these modes of transactions would be even more cluttered. This approach of showing just one mode of transaction at a time would then be a much better, nicer and modular way of presentation of the diagram to the user.

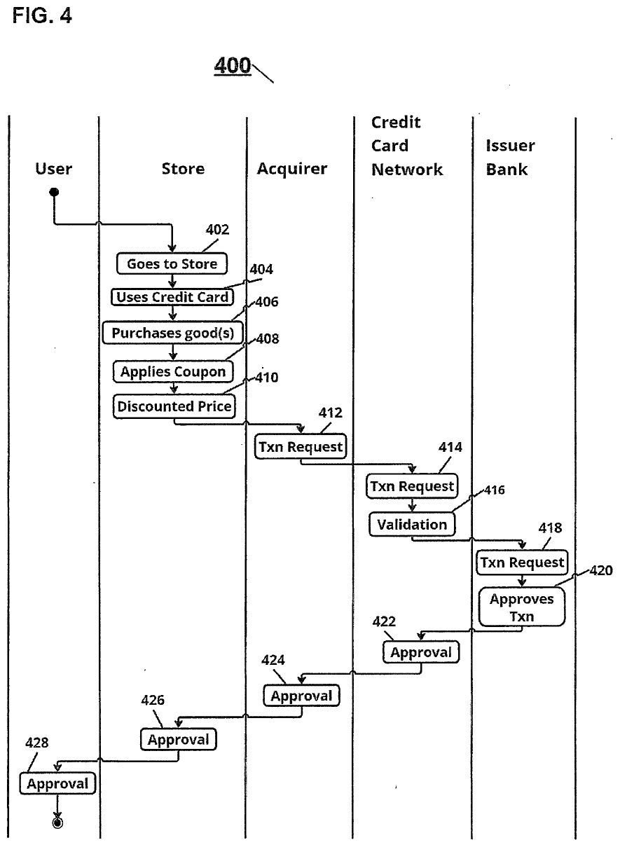

In the example UML swim lane activity diagram that we have taken, diagram, FIG. 4 shows a reduced version of the diagram FIG. 3, for just the in-store credit card transaction with the coupon applied using UML activity diagram drawing tools of today. But this requires changing the UML diagram to remove the two conditions.

Another reduced variation of the diagram, FIG. 3 using UML diagram drawing tools of today is showing the same In-store transaction without applying the coupon. This also requires changes to the UML script to remove the conditions. Since it is intuitive, a corresponding diagram is not given.

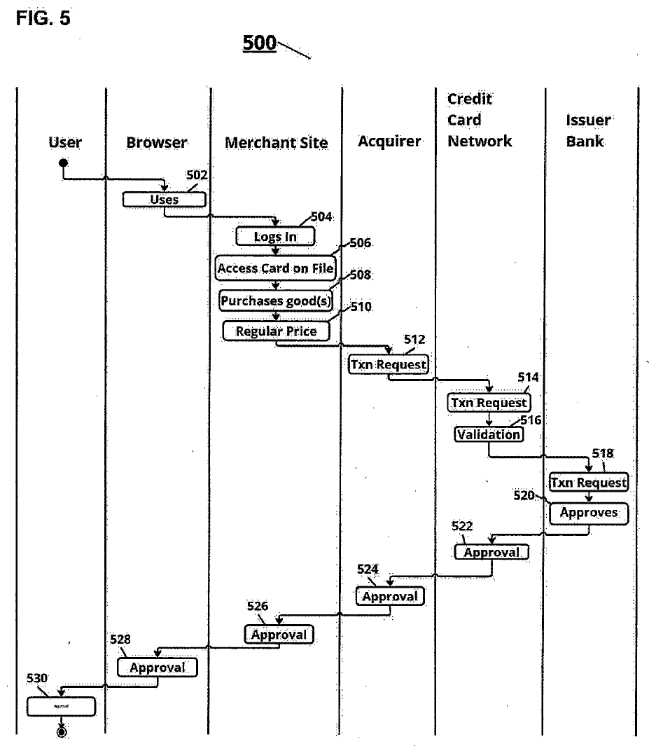

Another variation in the presentation by UML diagram drawing tools of today is showing the diagram for online card on file transaction without the coupon applied as shown in the diagram FIG. 5. This also requires modification of the UML script.

Another variation of the diagram, FIG. 5 by UML diagram drawing tools of today is showing the same online card on file transaction with the coupon applied. Since it is intuitive, a corresponding diagram is not given. This also requires changes to the original UML activity script.

CONDITIONS: For making the presentation of the UML swim lane activity diagram simpler and modular, the invention needs to look for optional or mutually exclusive set of sections and show just one of the sections at a time. The invention finds these set of sections based on the conditions in the script. In the UML activity diagram script example “SCRIPT_PURCHASE_CLUTTERED.UML”, one such condition is the if condition in the line, “if (In-Store) then (yes)”. Another independent condition is the line, “if (coupon applied) then (yes)”.

POSSIBLE LIST OF VALUES OF THE CONDITIONS: The values that are possible for these conditions are “True” for the if section and “False” for the else section. This is because the condition in the specification of the example is not parameterized but is just a string, “In-Store”. So, the invention identifies the possible values as the boolean list from the presence of if and else sections.

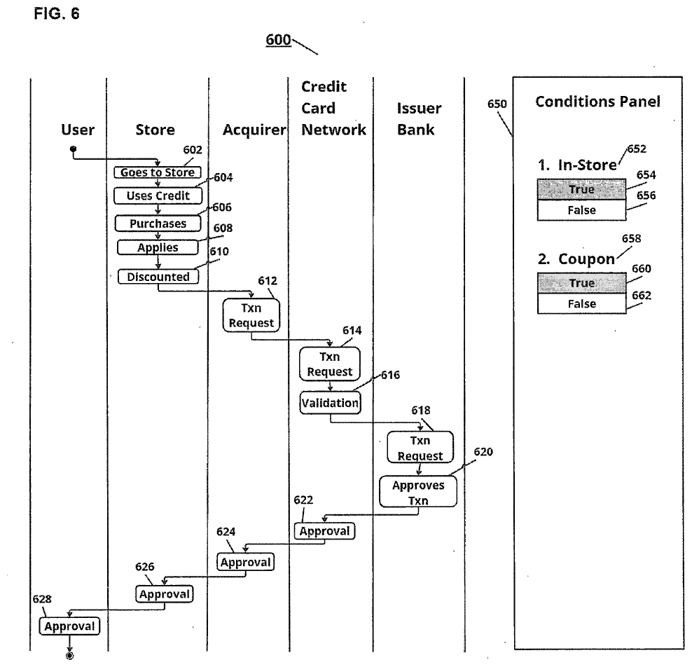

FIRST ROUND OF RENDERING BY INVENTION: The invention software applies default values to these conditions for drawing the first presentation of the diagram to the user. Default Value: The invention software assumes the values for the corresponding if section as default, which is “True” and draws the diagram. Additionally, the invention also displays editable labels for the conditions, their possible list of editable values along side the diagram as shown in the diagram FIG. 6.

The diagram, FIG. 6 shows the first round rendering by the invention.

As shown in the diagram FIG. 6, the invention software after parsing the script for conditions and options, applies default values for these conditions, namely, “True” for both “In-Store” and “Coupon” and draws
the default reduced swim lane activity diagram.
Conditions Panel as shown by reference number 650, condition labels, “In-Store” and “Coupon” as shown by reference numbers, 652 and 658 of FIG. 6, list of its possible values, “True” and “False” for both the conditions as shown by reference numbers, (654 and 656) and (660 and 662) of FIG. 6.

The invention software also shows selected list values highlighted in real time as shown by reference numbers 654 and 660 of FIG. 6. Condition labels and their possible list of values are read or inferred by the invention software from the script itself.

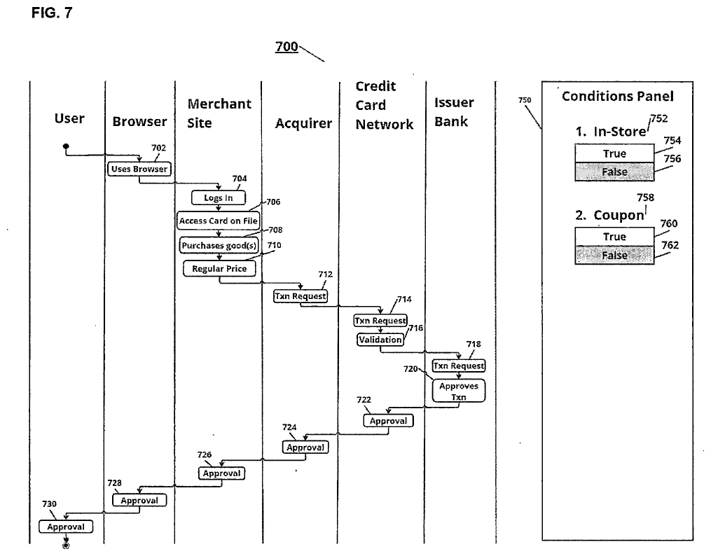

USER INTERACTIONS AND THE INVENTION'S RESPONSE: If the user selects “False” for the two conditions from the drop down list in the conditions panel, the invention software would then re-draw the diagram according to the new selected values of the conditions. It would draw the transaction for online without the coupon being applied as shown in the diagram FIG. 7, reference numbers, 702 to 730. The Conditions Panel is updated by the invention software to show the new selected values of “False” for both the conditions highlighted as shown by reference numbers 756 and 762 of FIG. 7.

NOVELTY OF THE INVENTION: This example with the diagrams FIG. 6 and FIG. 7 shows that the invention software makes the diagram modular, user interactive and dynamically responsive in real time. This is a novel feature that is not to be found in any of the current UML swim lane activity diagram drawing tools as of now.

ADDITIONAL FEATURES OF THE INVENTION: The invention software has the following additional features. RE-DEFINING OF CONDITIONS: The invention software allows the user to re-define the conditions themselves. RE-DEFINING OF POSSIBLE VALUES: The invention software also allows the user to re-define the list of possible values for the conditions, either all of them or a partial set of them. CAVEAT: The invention software makes sure that one value from the list of possible values, either read from the script or re-defined by the user accounts for one mutually exclusive section of the corresponding condition. The invention software can enforce it by highlighting the section of the script corresponding to the condition or the value that the user is trying to re-define. How the user re-defines the condition and the list of possible values is left to the user. What is important for the invention is that every mutually exclusive section corresponds to one of the values from the possible list of values, either read by the invention software or re-defined by the user.

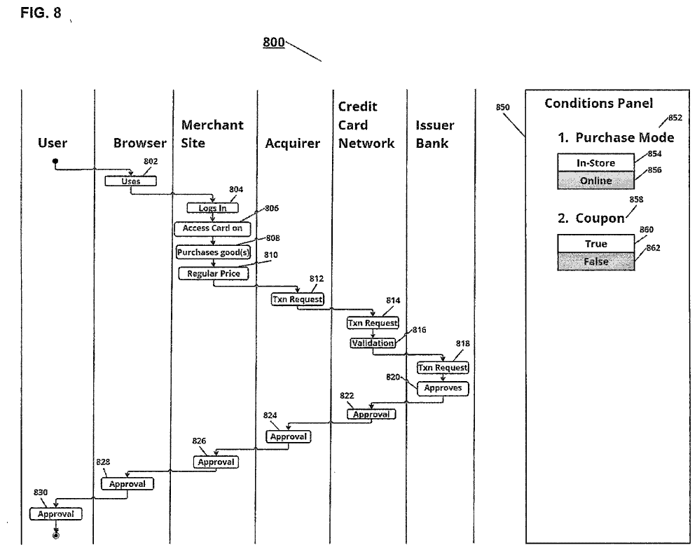

The Diagram, FIG. 8 shows an example of how the user might re-define the condition, “In-Store” and its list of possible values.

FIG. 8 shows how the user might re-define the condition, “In-Store”. They could re-define it more meaningfully as “Purchase mode” as shown by FIG. 8, reference number 852. Since the definition of the condition is changed, the old list of values, namely, “True” and “False” do not hold good for the new definition. So, the invention also allows the user to re-define the list of possible values as well. FIG. 8, reference number 854 and 856 show an example of the user redefining list values, “True” to “In-Store” and “False” to “Online”. The validation of the values is up to the user. The type and value validation of the condition and the list of possible values depend on the UML or non UML script specification and is out of scope of the invention.

SCOPE OF THE INVENTION: Apart from activity diagrams, Swim lane activity diagrams, the invention also applies to other UML diagram types such as sequence diagram, component diagram etc. It also applies to other UML specifications such as those defined in https://sequencediagram.org/or any other diagram type of any specification, where there is scope for modularization of presentation.

INVENTION IN SEQUENCE DIAGRAM: The following example, “EXAMPLE_SEQUENCE_SCRIPT” shows how the invention also applies to another UML diagram type, namely a sequence diagram, where there is scope for modularized presentation. The example is written using sequence diagram specification defined in https://sequencediagram.org/. It shows that the customer logs in to the online banking account, checks the account balance in the saving account. If it is above $1000, they transfer $800 from saving account to the connected checking account. If the balance in the saving account is higher than $300 and is less than or equal to $1000, they transfer $200 from saving account to the connected checking account and if the balance is less than or equal to $300, they do not transfer any amount. This example script can be verified by copying and pasting to the site, https://sequencediagram.org/.

### EXAMPLE_SEQUENCE_SCRIPT:

participant Customer
participant Bank_Server
Customer−>Bank_Server: Login
Bank_Server−>Customer: Logged In
Customer−>Bank_Server: Retrieve Saving Balance
Bank_Server−>Customer: Balance
alt Balance > $1000
Customer−>Bank_Server: Transfer $800 to Checking
Bank_Server−>Customer: Done
else
alt $1000 >= Balance >$300
Customer−>Bank_Server: Transfer $200 to Checking
Bank_Server−>Customer: Done
end
end
Customer−>Bank_Server: Log out
Bank_Server−>Customer: Logged out

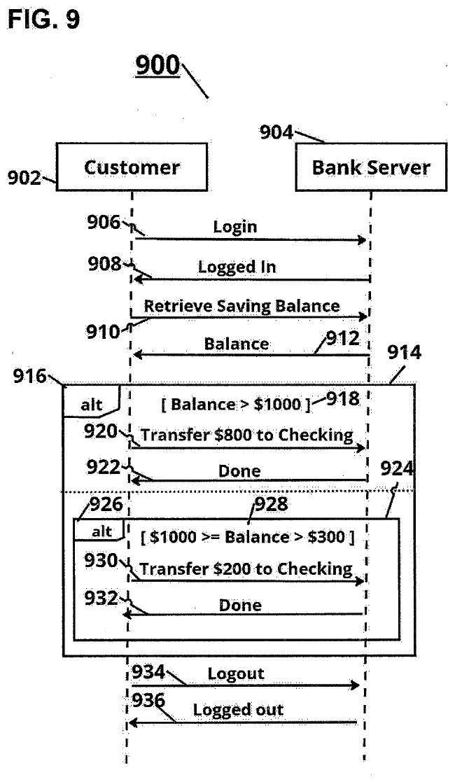

The diagram, FIG. 9 shows how the current UML drawing tools of today draw the sequence diagram for the script, “EXAMPLE_SEQUENCE_SCRIPT” for all the mutually exclusive sections of script, namely, 1) “Balance>$1000”, 2) “Balance<=$1000” and within “Balance<=$1000”, two other mutually exclusive sections corresponding to 1) “$1000>=Balance>$300” and 2) “Balance<=$300”.

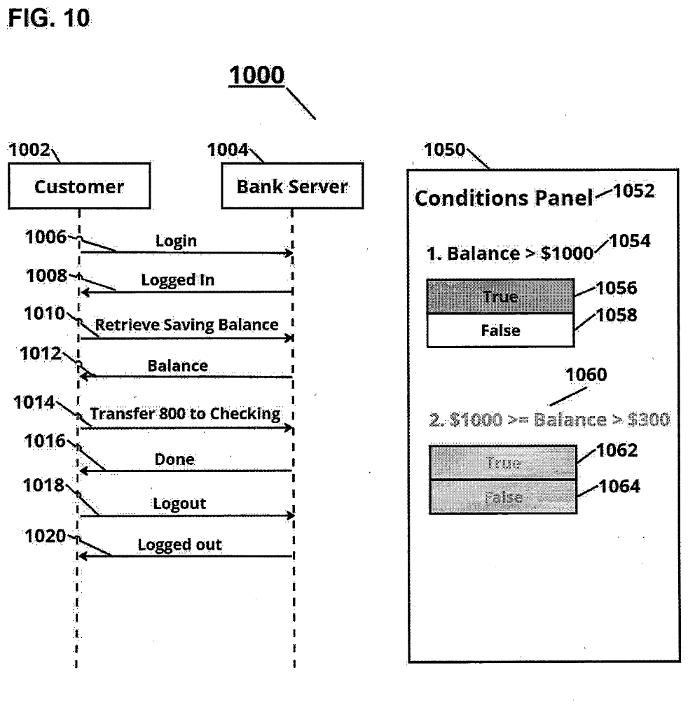

Diagram, FIG. 10 shows how the invention software shows the default presentation to the user. The invention software shows the two conditions “Balance>$1000” and “$1000>=Balance>$300” in the Conditions Panel as shown by reference numbers, 1054 and 1060 of FIG. 10. Since the second condition is within the first condition being false, the second condition is not applicable, if the first condition's selected value is “True”.

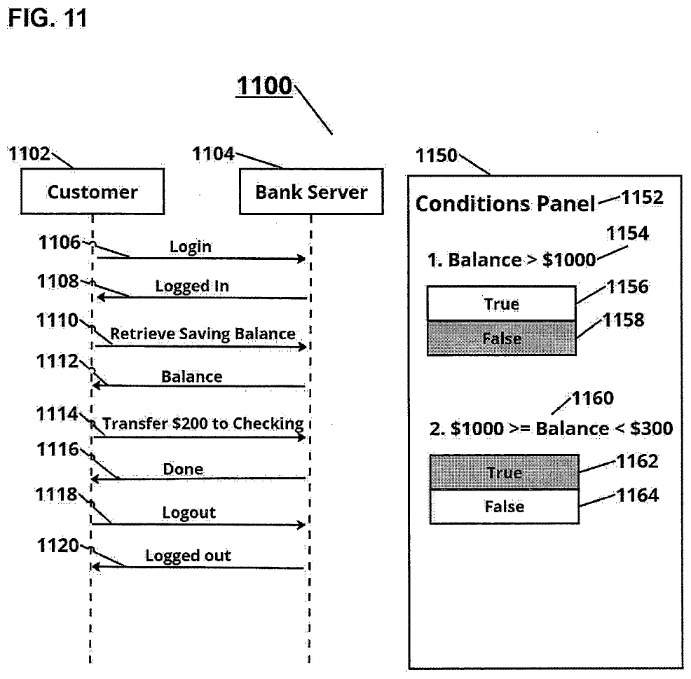

So, the invention software disables the second condition, “$1000>=Balance>$300” and its list values “True” and “False” and shows them disabled by highlighting these items using light gray font color as well light gray background as shown by reference numbers 1060, 1062 and 1064 of FIG. 10. FIG. 11 shows how the invention software updates the sequence diagram as the user chooses value “False” for the condition, “balance>$1000”.

Since the newly selected value of the condition, “Balance>$1000” has been changed to “False”, the invention software highlights the selected value by showing it in dark gray background as shown by reference number 1158 of FIG. 11 and showing the now non selected item “True” with clear background as shown by reference number 1156.

Since the second condition, “$1000>=Balance>$300” is now valid, the invention software enables the second condition and its list values as shown by reference numbers 1160, 1162 and 1164 of FIG. 11. Then the software chooses “True” as the default value for the second condition by highlighting its “True” list value in dark gray as shown by reference number 1162 of FIG. 11. The invention software also updates the sequence diagram according to the newly selected values, “False” and “True” for the first and the second conditions as shown by reference numbers 1106 to 1120 of FIG. 11.

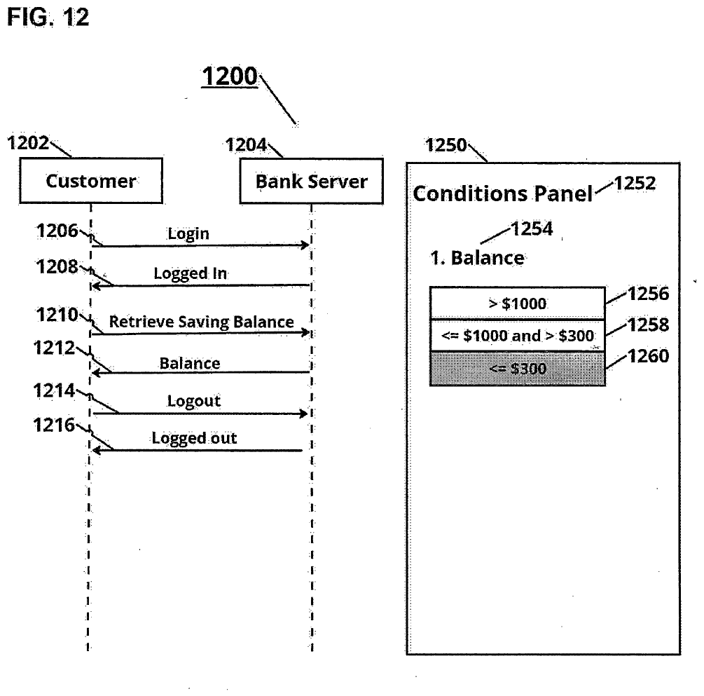

INVENTION UNIFYING NESTED SECTIONS: The user could re-define the two nested conditions, namely, “balance>$1000” and “$1000>=Balance>$300” into a single user re-defined condition, namely, “Balance” with the values now clubbed into 3 values and re-defined as 1) “>$1000, 2)<=$1000< and >$300 and 3)<=$300 as shown in the diagram, FIG. 12. This is an example of the invention consolidating multiple conditions of nested sections into a single condition. Here the invention shows an updated sequence diagram as the user selects”<=$300″ option from the newly clubbed redefined list values.

The invention software can highlight the section in the diagram, which the user is redefining the value for the condition and/or its list values to help the user understand, which actual section of the diagram that they are actually redefining the condition and/or the value for. The user interface might also allow clubbing of nested sections into one condition by highlighting relevant portions of the diagram, if that is possible as in this example.

### REFERENCES

Sequence Diagram: https://sequencediagram.org/
plantUML—https://plantuml.com

1) The idea that the invention identifies the branching points of the UML and non UML scripts, the corresponding branching conditions and the values of the condition for mutually exclusive branch sections of all branching points, with the condition that the scripts allow branching that is based on conditions.

2) The idea that the invention assigns a default branch values for all the UML and non UML script branch conditions and show the user an initial reduced presentation of the diagram.

3) The idea that the invention allows the user to interact with the UML and non UML diagrams in real time and to update the diagrams in real time.

4) The idea that the invention implements interaction of the user mentioned in claim 3 by allowing the user to optionally re-define the branch conditions read by the invention from the UML or non UML script.

5) The idea that the invention implements interaction of the user mentioned in claim 3 by allowing the user to optionally re-define either all or a partial list of possible values of the branch conditions, read by the invention from the script.

6) The idea that the invention implements interaction of the user mentioned in claim 3 by allowing the user to optionally re-select different chosen values for the branch conditions to view the different versions of the UML or non UML diagram.

7) The idea that the invention provides dynamic responses to the interactions from the user mentioned in claim 3 by updating the UML or non UML diagram in real time with different versions corresponding to the user's new set of values chosen for the branch conditions.
